(19) United States
(12) Patent Application Publication
(10) Pub. No.: US 2025/0369929 A1
(43) Pub. Date: Dec. 4, 2025

(54) ULTRASONIC PHASED ARRAY SENSOR

(71) Applicant: Suncall Corporation, Kyoto-shi, Kyoto (JP)

(72) Inventor: Satoru TAKASUGI, Kyoto-shi, Kyoto (JP)

(21) Appl. No.: 18/865,304

(22) PCT Filed: May 13, 2022
(86) PCT No.: PCT/JP2022/020234

§ 371 Date: Aug. 25, 2025

(51) Int. Cl. G01N 29/26; G01N 29/24; G01N 29/34; G01N 29/42

(52) U.S. Cl. CPC G01N 29/262; G01N 29/245; G01N 29/343; G01N 29/42

(57) ABSTRACT

An ultrasonic phased array sensor of this invention includes non-resonant ultrasonic transducers, a transmission signal generation device generating rectangular burst wave driving voltage signal whose driving frequency is lower than the resonant frequency of the transducer, transmission-side channels transmitting driving voltage signals from the transmission signal generation device to transducers, a reception signal processing device, reception-side channels transmitting reception voltage signals that transducers generated to reception signal processing device, changeover switches switching connection of the transducers to the transmission-side channels and the reception-side channels, a detection device detecting a position of an obstacle, and transmission-side and reception-side filters inserted in the transmission-side and reception-side channels, respectively, the filters removing at least the resonant frequency components of the transducers while allowing the driving frequency components to pass.

### FIELD OF THE INVENTION

The present invention relates to a phased array sensor including an ultrasonic transducer array.

### BACKGROUND ART

In a case where transmission and reception of ultrasonic waves are performed using an ultrasonic transducer array having a plurality of ultrasonic transducers arranged in parallel, the ultrasonic transducer array is connected to a signal generation device when the array performs transmission of ultrasonic waves.

At this time, a driving voltage including a predetermined driving frequency component is sequentially applied to the plurality of ultrasonic transducers with a certain phase difference, and the array radiates ultrasonic waves at an azimuth angle corresponding to the phase difference.

On the other hand, when the array performs reception of ultrasonic wave, the array receives ultrasonic waves (received ultrasonic waves) that are reflected back from an obstacle, and generates a voltage signal (received voltage signal) based on the received ultrasonic waves.

At this time, the array is disconnected from the signal generation device and connected to a signal reception device.

The signal reception device is configured to sequentially delay received voltage signals generated by the plurality of ultrasonic transducers by predetermined time, and add the received voltage signals that are delayed. Herein, the delay time for the received voltage signal is set so as to add a received voltage signal based on a received sonic wave from the same azimuth angle as the azimuth angle of the radiated sonic wave.

Therefore, the array is used as a phased array sensor capable of detecting the position of an obstacle over a wide range by changing the phase difference of the driving voltage to the plurality of ultrasonic transducers (and the delay time of the received voltage signal that is set corresponding to the phase difference).

However, a conventional phased array sensor has the following problems.

That is, as the driving voltage applied to each ultrasonic transducer, a rectangular wave burst voltage signal including a predetermined driving frequency component, which is generated by an easily controllable digital circuit, is typically used.

In the array, in order to cause the ultrasonic transducers to resonate with a sufficiently large amplitude during the operation of transmitting ultrasonic waves, the ultrasonic transducer is generally resonated in a resonant manner.

Specifically, a driving voltage signal whose main component is the resonant frequency of the ultrasonic transducer, preferably a rectangular wave burst wave driving voltage signal generated using the easily controllable digital circuit, is applied to each ultrasonic transducer, so that the ultrasonic transducers are caused to resonate and emit ultrasonic waves.

In this case, when the driving voltage signal is applied, sonic waves of a resonant frequency are emitted from the ultrasonic transducers, and the ultrasonic transducers perform damped resonation at the resonant frequency for a certain period of time after application of the driving voltage signal (rectangular burst wave driving voltage signal) is terminated.

Therefore, in a case where an obstacle is located nearby, the ultrasonic transducers receive ultrasonic waves that reflect on the obstacle and return during damped vibration, and the vibration generated by the received sonic waves may overlap with the damped vibration.

It is preferable to set the gain of an amplifier provided in the signal reception device as high as possible without distorting the waveform of the received sonic pressure signal. However, the damped vibration at the resonant frequency is usually much greater than vibration caused by received sonic waves. Accordingly, if the amplification gain of the amplifier is set high, operational saturation of the amplifier is caused, and it is impossible to amplify the received voltage signal while maintaining the waveform of the received voltage signal.

There is also a type of phased array sensor in which a transmission transducer array and a reception transducer array are separate (see Patent Literature 1 below). In this type of phased array sensor, a problem of difficulty in amplifying the received voltage signal as described above due to damped vibration after the transmission operation does not occur. However, if the damped vibration of the transducers in the transmission and/or reception transducer array continues for a long time, the distance resolution of obstacle detection decreases.

An applicant of the present application filed a patent application for an invention relating to a non-resonant ultrasonic transducer array, which is different from the resonant ultrasonic transducer array described above, and has obtained a patent for the invention (see Patent Literature 1 below).

The non-resonant ultrasonic transducer array is useful in that by setting the resonant frequency of the ultrasonic transducers higher than the driving frequency (e.g., 40 kHz), the phase of vibration at the driving frequency can be precisely controlled without being affected by fluctuation in the resonant frequency when the non-resonant ultrasonic transducer array is operated as a phased array.

As a result of extensive research regarding this non-resonant ultrasonic transducer array, the inventor of the present application has discovered the following new problems.

In a case where a rectangular burst wave driving voltage signal having a driving frequency lower than the resonant frequency is applied to the ultrasonic transducers of the non-resonant ultrasonic transducer array, a signal including a resonant frequency component higher than the driving frequency is applied to the ultrasonic transducers.

That is, the ultrasonic transducer is excited not only by vibration at the driving frequency but also by vibration at the resonant frequency, and a situation in which the vibration waveform of the ultrasonic waves radiated from the ultrasonic transducers is distorted with respect to the vibration waveform of the driving frequency may be caused.

Furthermore, a problem caused by the damped vibration at the resonant frequency of the ultrasonic transducers may occur after application of the driving voltage signal is terminated.

In addition, Patent Literature 2 listed below discloses a phased array sensor including an ultrasonic transducer array having a plurality of ultrasonic transducers, a signal generation device that supplies a driving voltage signal to the ultrasonic transducer array, and a signal reception device that receives a received voltage signal from the ultrasonic transducer array, and the signal reception device being provided with a filter circuit.

However, the filter circuit of Patent Literature 2 is for removing noise and the like, and Patent Literature 2 makes no mention of a problem caused by damped vibration of the ultrasonic transducer at the resonant frequency.

### PRIOR ART DOCUMENT

### Patent Literature

Patent Literature 1: Japanese Patent No. 6776481

Patent Literature 2: Japanese Patent Publication No. H11-248821

### SUMMARY OF THE INVENTION

The present invention has been made in consideration of the conventional technology, and it is an object to provide a phased array sensor including a non-resonant ultrasonic transducer array, the phased array sensor capable of transmitting and receiving ultrasonic waves while preventing or reducing an adverse effect due to damped vibration at the resonant frequency of an ultrasonic transducer.

In order to achieve the object, a first aspect of the present invention provides an ultrasonic phased array sensor including a transducer array including a plurality of non-resonant aerial ultrasonic transducers arranged at a predetermined interval; a transmission signal generation device including a plurality of signal generating means corresponding to the plurality of transducers, respectively, the signal generating means capable of a generating rectangular burst wave driving voltage signal, which has a predetermined driving frequency lower than the resonant frequency of the transducer, at a delay timing set for the corresponding transducer; a plurality of transmission-side channels electrically connected to the plurality of signal generating means, respectively; a plurality of transmission-side filters inserted in the plurality of transmission-side channels, respectively; a plurality of reception-side channels capable of receiving reception voltage signals generated by the plurality of transducers, respectively; a plurality of reception-side filters inserted in the plurality of reception-side channels, respectively; a reception signal processing device including a plurality delay circuits capable of delaying the reception voltage signals of the plurality of reception-side channels by respective predetermined times, an adder circuit that adds output signals of the plurality of delay circuits, and a detector that generates a signal having a width corresponding to a duration of an output signal of the adder circuit; a control device that controls the transmission signal generation device and the reception signal processing device; a detection device that detects a position of an obstacle on the basis of a time difference between a transmission timing signal that is based on the driving voltage signal sent from the control device and a reception timing signal that is based on the reception voltage signal sent from the detector sent from the detector, as well as an azimuth angle information sent from the control device; and a plurality of changeover switches that changeover operating states of the plurality of transducers between a transmission operating state and a reception operating state, respectively, on the basis of a control signal from the control device, wherein the plurality of transmission-side filters and the plurality of reception side filters are configured to remove at least the resonant frequency components of the transducers while allowing the driving frequency components to pass.

According to the ultrasonic phased array sensor of the first aspect of the present invention, it is possible to transmit and receive ultrasonic waves while preventing or reducing an adverse effect due to damped vibration at the resonant frequency of an ultrasonic transducer.

In a first configuration, the transmission-side filter and/or the reception-side filter may be a band-pass filter configured to remove the resonant frequency component of the transducer while allowing the driving frequency component to pass

The bandpass filter is configured to pass only frequency component within ±10% of the driving frequency in a preferable configuration, and also pass only frequency component within ±1% of the driving frequency in a more preferable configuration.

In a second configuration, the transmission-side filter and/or the reception-side filter may be a low pass filter or a band-reject filter configured to remove the resonant frequency component of the transducer while allowing the driving frequency component to pass.

The ultrasonic phased array sensor according to any one of the above configurations may further include a plurality of low-noise amplifier circuits inserted in the plurality of reception-side channels, respectively, downstream of the plurality of reception-side filters in a signal transmission direction.

A second aspect of the present invention provides an ultrasonic phased array sensor including a transmission transducer array including a plurality of non-resonant aerial ultrasonic transmission transducers arranged at a predetermined interval; a transmission signal generation device including a plurality of signal generating means corresponding to the plurality of transmission transducers, respectively, the signal generating means capable of a generating rectangular burst wave driving voltage signal, which has a predetermined driving frequency lower than the resonant frequency of the transmission transducer, at a delay timing set for the corresponding transmission transducer; a plurality of transmission-side channels electrically connected to the plurality of signal generating means, respectively; a plurality of transmission-side filters inserted in the plurality of transmission-side channels, respectively; an aerial ultrasonic reception transducer capable of receiving return ultrasonic waves that has been transmitted from the plurality of transmission transducers and then reflected back from an obstacle to be detected; a reception-side channel capable of receiving a reception voltage signal generated by the reception transducer; a reception-side filter inserted in the reception-side channel; a reception signal processing device including a detector that generates a signal having a width corresponding to a duration of an output signal of the reception-side channel; a control device that controls the transmission signal generation device and the reception signal processing device; and a detection device that detects a position of an obstacle on the basis of a time difference between a transmission timing signal that is based on the driving voltage signal sent from the control device and a reception timing signal that is based on the reception voltage signal sent from the detector, as well as an azimuth angle information sent from the control device, wherein the plurality of transmission-side filters are configured to remove at least the resonant frequency components of the transducers while allowing the driving frequency components to pass.

A third aspect of the present invention provides an ultrasonic phased array sensor including a transmission transducer array including a plurality of non-resonant aerial ultrasonic transmission transducers arranged at a predetermined interval; a transmission signal generation device including a plurality of signal generating means corresponding to the plurality of transmission transducers, respectively, the signal generating means capable of a generating rectangular burst wave driving voltage signal, which has a predetermined driving frequency lower than the resonant frequency of the transmission transducer, at a delay timing set for the corresponding transmission transducer; a plurality of transmission-side channels electrically connected to the plurality of signal generating means, respectively; a plurality of transmission-side filters inserted in the plurality of transmission-side channels, respectively; a reception transducer array including a plurality of aerial ultrasonic reception transducers that correspond to the plurality of transmission transducers; a plurality of reception-side channels capable of receiving reception voltage signals generated by the plurality of reception transducers, respectively; a plurality of reception-side filters inserted in the plurality of reception-side channels, respectively; a reception signal processing device including a plurality delay circuits capable of delaying the reception voltage signals of the plurality of reception-side channels by respective predetermined times, an adder circuit that adds output signals of the plurality of delay circuits, and a detector that generates a signal having a width corresponding to a duration of an output signal of the adder circuit; a control device that controls the transmission signal generation device and the reception signal processing device; and a detection device that detects a position of an obstacle on the basis of a time difference between a transmission timing signal that is based on the driving voltage signal sent from the control device and a reception timing signal that is based on the reception voltage signal sent from the detector, as well as an azimuth angle information sent from the control device, wherein the plurality of transmission-side filters are configured to remove at least the resonant frequency components of the transducers while allowing the driving frequency components to pass.

In the second and third aspects, the reception transducer may be a resonant type transducer that performs resonant vibration at the driving frequency of the driving voltage signal generated by the transmission signal generation device.

Alternatively, the reception transducer may be a non-resonant type transducer having a resonant frequency higher than the driving frequency of the driving voltage signal generated by the transmission signal generation device.

In a case where the reception-side filter is a resonant type transducer, the reception-side filter is configured to remove at least the resonant frequency component of the reception transducer while allowing the driving frequency components to pass.

### BRIEF DESCRIPTION OF THE DRAWINGS

FIG. 1 is a schematic block diagram of an ultrasonic phased array sensor according to a first embodiment of the present invention.

FIG. 2 is a vertical cross-sectional side view of a transducer array in the phased array sensor.

FIG. 3 is an end view taken along the line III-III in FIG. 2., and omits some of components of the transducer array.

FIG. 4A is a plan view of a piezoelectric element forming a transducer of the transducer array, and FIG. 4B is a cross-sectional view taken along the line IV-IV in FIG. 4A.

FIG. 5 is a schematic block diagram of a control device and a transmission-side unit of the phased array sensor.

FIG. 6 is a schematic diagram showing an operation of the transducer array that radiates ultrasonic waves in response to a driving voltage signal supplied from the transmission-side unit.

FIG. 7 is a schematic block diagram of a reception-side unit and the control device of the phased array sensor.

FIG. 8 is a schematic diagram showing operation of the reception-side unit that processes a reception voltage signal generated by the transducer array in response to reception of an ultrasonic wave.

FIGS. 9A and 9B are diagrams showing output signals of an adder and a detector of the reception-side unit, respectively, FIG. 9C is a diagram showing a reception timing signal of a reception voltage signal that is generated on the basis of the output signal of the detector, and FIG. 9D is a diagram showing a transmission timing signal that is generated on the basis of s signal sent from the control device.

FIG. 10 is a schematic block diagram of an ultrasonic phased array sensor according to a modified example of the first embodiment.

FIG. 11 is a schematic block diagram of an ultrasonic phased array sensor according to a second embodiment of the present invention.

FIG. 12 is a schematic block diagram of an ultrasonic phased array sensor according to a third embodiment of the present invention.

### EMBODIMENT FOR CARRYING OUT THE INVENTION

### First Embodiment

An embodiment of a phased array sensor according to the present invention will be hereinafter described with reference to the accompanying drawings.

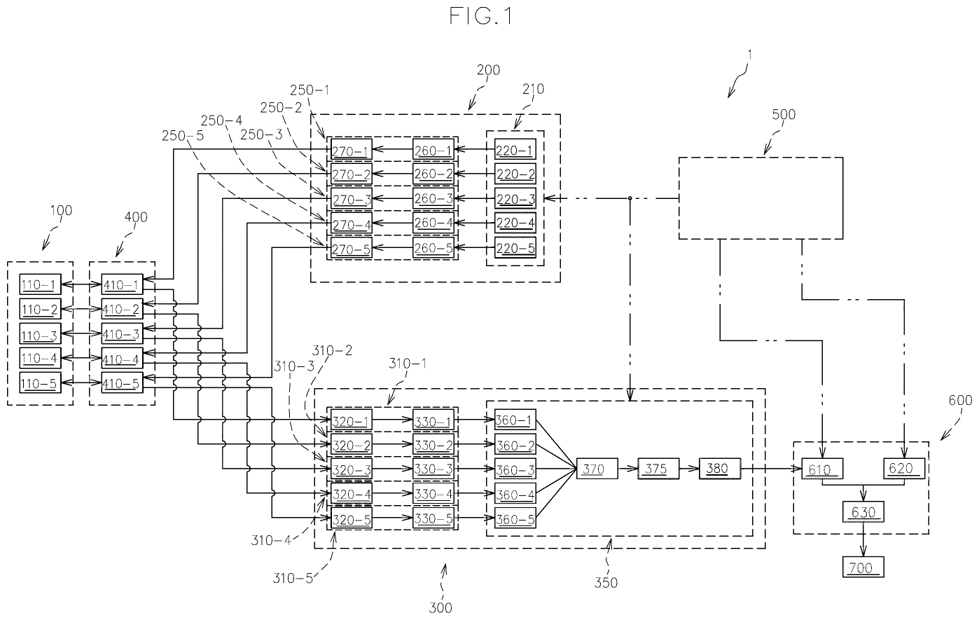

FIG. 1 illustrates a schematic block diagram of a phased array sensor 1 according to this embodiment.

As illustrated in FIG. 1, the phased array sensor 1 includes:
a transducer array 100 including first to n-th (n is an integer of 2 or more) non-resonant aerial ultrasonic transducers 110 (first to fifth transducers 110-1 to 110-5 in FIG. 1) that are arranged at a predetermined interval;
a transmission-side unit 200 capable of supplying a driving voltage signal to each of the first to n-th transducers 110;
a reception-side unit 300 that processes a reception voltage signal generated by each of the first to n-th transducers 110 in response to reception of an ultrasonic wave;
a switching unit 400 capable of switching between an ultrasonic wave transmission operating state and an ultrasonic wave reception operating state of the transducer array 100;
a control device 500 that controls the transmission-side unit 200, the reception-side unit 300, and the switching unit 400; and
a detection device 600 that detects a position of an obstacle on the basis of information regarding the driving voltage signal from the control device 500 and information regarding the reception voltage signal from the reception-side unit 300.

Now, the transducer array 100 will be described.

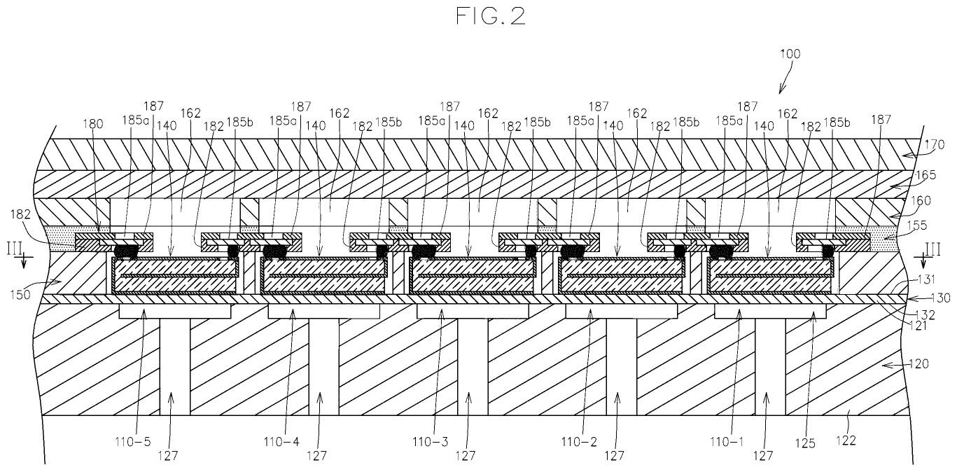

FIG. 2 illustrates a vertical cross-sectional side view of the transducer array.

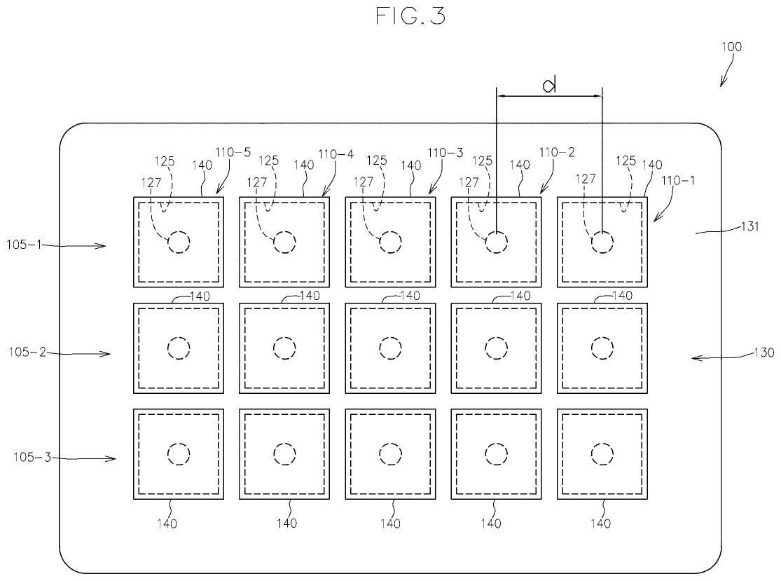

FIG. 3 illustrates an end view of the transducer array taken along the line III-III in FIG. 2. In FIG. 3, some of components of the transducer array are omitted for ease of understanding.

As illustrated in FIG. 2 and FIG. 3, in this embodiment, the transducer array 100 has three rows of transducer rows 105-1 to 105-3, and the five transducers 110 (first to fifth transducers) are arranged in series at predetermined intervals in each of the three rows of transducer rows 105-1 to 105-3.

In FIG. 1, the five transducers 110 in a row are illustrated.

Each transducer 110 is a non-resonant type transducer that effectively generates ultrasonic waves by a driving voltage having a frequency lower than the frequency of the lowest resonant mode of the transducer 110.

In detail, as illustrated in FIG. 2, the transducer array 100 includes, as main components thereof, a rigid support plate 120 having a first surface 121 on one side in the thickness direction and a second surface 122 on the other side in the thickness direction, a flexible resin film 130 having a first surface 131 on one side in the thickness direction and a second surface 132 on the other side in the thickness direction, the second surface 132 being fixed to the first surface 121 of the support plate 120, and first to n-th (five in the figure) piezoelectric elements 140 fixed to the first surface 131 of the flexible resin film 130, and the first to n-th piezoelectric elements 140 and corresponding portions of the flexible resin film 130 form first to n-th transducers 110.

As illustrated in FIG. 2 and FIG. 3, the support plate 120 is provided with the same number of (fifteen in a 3×5 arrangement in this embodiment) recesses 125 as the piezoelectric elements 140, each of which is opened to the first surface 121 of the support plate 120, and the same number of (fifteen in a 3×5 arrangement in this embodiment) waveguides 127, each of which has a first end on one end side that is opened to a bottom surface of each of the plurality of recesses 125 and a second end on the other end side that is opened to the second surface 122 of the support plate 120.

In this embodiment, the waveguides 127 are cylindrical in shape and each have an opening width that is smaller than that of the recess 125 and constant throughout the thickness direction.

The support plate 120 can be formed of various materials having rigidity, and can be formed of metal such as stainless steel, and preferably a ceramic material such as SiC or Al2O3, which has a lower density and a higher Young's modulus than metal.

As illustrated in FIG. 2 and FIG. 3, in this embodiment, the support plate 120 is a single plate integrally including a portion in which the plurality of recesses 125 are formed and a portion in which the plurality of waveguides 127 are formed, but the support plate 120 may be a laminated structure.

That is, it is also possible to form the support body 120 formed by fixing a first plate body (not illustrated) in which the plurality of recesses 125 are formed and a second plate body (not illustrated) which is separate from the first plate and has a larger plate thickness and in which the plurality of waveguides 127 are formed, in a laminated state in the thickness direction.

The flexible resin film 130 is fixed to the first surface 121 of the support plate 120 so as to cover the plurality of recesses 125.

The flexible resin film 130 is formed of insulating resin such as polyimide having a thickness of 20 μm to 100 μm.

The flexible resin film 130 is fixed to the support plate 120 by various methods such as adhesive and thermocompression bonding.

As illustrated in FIG. 3, the piezoelectric elements 140 are fixed to the first surface 131 of the flexible resin film 130 such that central regions of the piezoelectric elements 140 overlap with corresponding recesses 125 and peripheral regions of the piezoelectric elements 140 overlap with the first surface 121 of the support plate 120 in plan view.

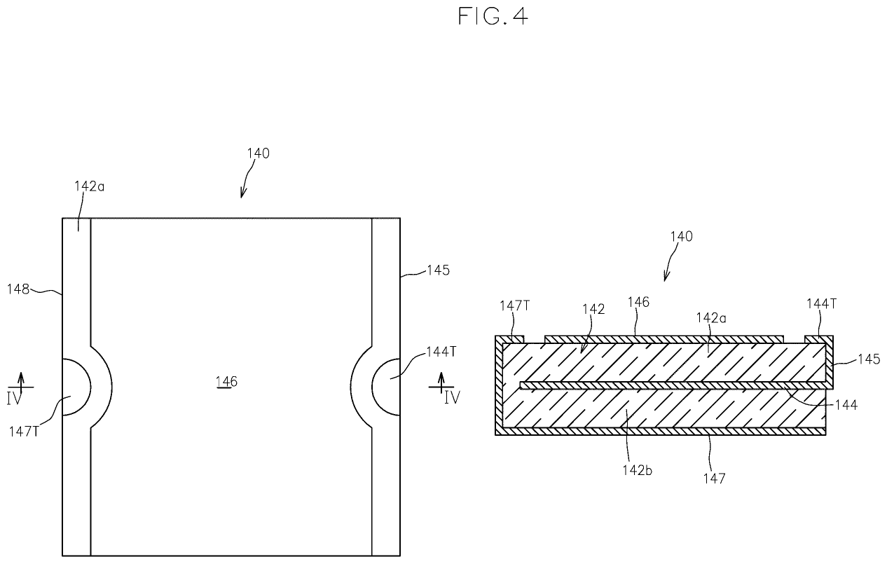

FIG. 4A illustrates a plan view of the piezoelectric element 140.

FIG. 4B illustrates a cross-sectional view taken along the line IV-IV in FIG. 4A.

The piezoelectric element 140 has a piezoelectric element body 142 and a pair of first and second electrodes, and is configured to expand and contract when a voltage is applied between the first and second electrodes.

In this embodiment, the piezoelectric element 140 is of a multilayer laminated type.

Compared to the single-layer piezoelectric element, multilayer laminated piezoelectric element can increase the electric field strength when the same voltage is applied, and can increase the expansion and contraction displacement per applied voltage.

In detail, the piezoelectric element 140 includes the piezoelectric element body 142 formed of a piezoelectric material such as lead zirconate titanate (PZT), an inner electrode 144 that divides the piezoelectric element body 142 into a first piezoelectric portion 142a on the upper side and a second piezoelectric portion 142b on the lower side in the thickness direction, an upper surface electrode 146 fixed to a part of the upper surface of the first piezoelectric portion 142a, a lower surface electrode 147 fixed to the lower surface of the second piezoelectric portion 142b, an inner electrode connection member 145 having one end that is electrically connected to the inner electrode 144 and the other end that forms an inner electrode terminal 144T accessible on the upper surface of the first piezoelectric portion 142a in a state of being insulated from the upper surface electrode 146, and a lower surface electrode connection member 148 having one end that is electrically connected to the lower surface electrode 147 and the other end that forms a lower surface electrode terminal 147T accessible on the upper surface of the first piezoelectric portion 32a in a state of being insulated from the upper surface electrode 146 and the inner electrode 34.

In this case, an outer electrode formed by the upper surface electrode 146 and the lower surface electrode 147 acts as one of the first and second electrodes, and the inner electrode 144 acts as the other of the first and second electrodes.

In the piezoelectric element 140, the first and second piezoelectric portions 142a and 142b have the same polarization direction in the thickness direction. Consequently, a predetermined voltage is applied between the outer electrode and the inner electrode 144 at a predetermined frequency, so that electric fields in opposite directions to each other are applied to the first and second piezoelectric portions 142a and 142b.

As described above, the upper surface electrode 146 and the lower surface electrode 147 are insulated from each other. Therefore, when the piezoelectric element 140 is made, the polarization directions of the first and second piezoelectric portions 142a and 142b can be made the same by applying a voltage between the upper surface electrode 146 and the lower surface electrode 147.

As described above, in the ultrasonic transducer array 100, the piezoelectric elements 140 and the flexible resin film 130 supporting the piezoelectric elements 140 act as the transducers 110 that generate ultrasonic waves in response to application of a driving voltage signal and generate a reception voltage signal in response to reception of the ultrasonic waves. The transducers 110 are each configured such that the resonance frequency in the lowest flexural vibration mode is greater than the frequency (driving frequency) of a voltage signal applied to the piezoelectric element 140.

That is, in order to detect an object several meters away by a phased array in which the plurality of piezoelectric elements 140 forming the transducers 110 are arranged in parallel, it is necessary to precisely control the phase of the sonic wave radiated from the plurality of transducers 110 formed by the plurality of piezoelectric elements 140.

For example, in a phased array in which a plurality of piezoelectric elements are directly arranged in parallel on a rigid support plate made of stainless steel or the like, it is necessary to expand and contract the piezoelectric elements against the rigidity of the rigid support plate so that vibrating bodies formed by the piezoelectric elements and the rigid support plate make flexural vibration with a predetermined amplitude to ensure the magnitude of generated sonic pressure.

In order to achieve the above, the frequency of the voltage applied to each piezoelectric element (driving frequency) needs to be set near the resonant frequency in the flexural vibration mode of the transducers formed by the piezoelectric element.

However, a phase of a frequency response in the flexural vibration mode of the transducer formed by the piezoelectric element with respect to the voltage applied to the piezoelectric element changes largely in the vicinity of the resonance frequency of the vibrating body.

Therefore, in order to precisely control the phase of the sonic waves generated by the plurality of transducers with the aim of achieving the function of a phased array sensor, it is necessary to suppress as much as possible “dispersion” in the resonance frequency among the plurality of transducers, which is very difficult.

With respect to this point, as described above, the ultrasonic transducer array 100 includes the rigid support plate 120 provided with the plurality of recesses 125 opened to the first surface 121 and the plurality of waveguides 127, each having the first end with the opening width smaller than the opening width of the recesses 125 opened to the bottom surface of the recesses 125 and the second end opened to the second surface 122, the flexible resin film 130 fixed to the first surface 121 of the support plate 120 so as to cover the plurality of recesses 125, and the plurality of piezoelectric elements 140 fixed to the first surface 131 of the flexible resin film 130 such that the central regions of the piezoelectric elements 140 overlap the corresponding recesses 125 and the peripheral regions of the piezoelectric elements 140 overlap the first surface 121 of the support plate 120, in plan view.

According to this configuration, even if the resonant frequency in the flexural vibration mode of the transducers 110 formed by the piezoelectric elements 140 is set to be higher than the driving frequency of the voltage signal applied to the piezoelectric elements 140, the vibration amplitude of the transducers 110 can be sufficiently secured.

Moreover, when the resonant frequency of each transducer 110 is higher than the driving frequency of the piezoelectric element 140, even if there is “dispersion” or “variation” in the resonant frequency among the plurality of transducers 110, no significant difference occurs in the phase of the frequency response in the flexural vibration mode of the plurality of transducers 110.

Therefore, the phase of the sonic waves generated by the plurality of transducers 110 can be precisely controlled.

In detail, in order to detect an object several meters away using the ultrasonic transducer array 100, the frequency of the ultrasonic wave radiated by the transducer 110 formed by each piezoelectric element 140 needs to be a low frequency of about 30 to 50 kHz.

When the resonant frequency of each transducer 110 is set to a resonant frequency (e.g., 70 kHz) that is sufficiently higher than the driving frequency (30 to 50 kHz) applied to the transducer 110, the sonic pressure of the ultrasonic waves generated by the transducer 110 can be increased by increasing the longitudinal and lateral dimensions in plan view of the piezoelectric element 140.

However, on the other hand, in a case where the plurality of transducers 110 (the plurality of piezoelectric elements 140) are arranged in parallel, as in the transducer array 100, it is necessary to make the arrangement pitch of the plurality of transducers 110 (the plurality of piezoelectric elements 140) equal to or less than half the wavelength λ of the ultrasonic waves radiated by the transducer 110, in order to suppress the occurrence of grating lobes in the sonic waves radiated from the plurality of transducers 110.

The wavelength λ of an ultrasonic wave with a frequency of 40 kHz is 8.6 mm, and therefore in order to suppress the occurrence of grating lobes while setting the frequency of the ultrasonic wave radiated by each transducer 110 at 40 kHz, it is necessary to set the arrangement pitch d (see FIG. 3) of the plurality of transducers 110 (plurality of piezoelectric elements 140) to 8.6 mm/2=4.3 mm or less.

Therefore, it is preferable that the longitudinal and lateral dimensions of the piezoelectric element 140 in a plan view are 3.0 mm or more from the viewpoint of ensuring sonic pressure, and 4.0 mm or less from the viewpoint of suppressing the generation of grating lobes.

In this embodiment, the piezoelectric elements 140 are each square in plan view. However, instead of this, the planar shape of the piezoelectric element 140 may be a rectangular shape including a rectangle having maximum longitudinal and lateral dimensions of 4.30 mm or less, a circular shape having a diameter of 4.0 mm or less, or an elliptical shape having a major axis of 4.0 mm or less.

The opening width of each recess 125 is set such that the frequency in the lowest resonant mode of the flexural vibration of the transducer 110 formed by each piezoelectric element 140 and the flexible resin film 130 is greater than the driving frequency of a voltage signal applied to the piezoelectric element 140 (driving frequency).

Preferably, the recesses 125 each have a similar shape to the piezoelectric element 140 in plan view such that an overlapping width between the peripheral region of each piezoelectric element 140 and the support plate 120 in plan view is 0.05 mm to 0.1 mm over the entire periphery of the piezoelectric element 140.

That is, in a case where each piezoelectric element 140 has a square shape with each side of 4.0 mm in plan view, the recess 125 preferably has a square shape with each side of 3.8 mm to 3.9 mm in plan view, and in a case where each piezoelectric element 140 has a circular shape with a diameter of 4.0 mm in plan view, the recess 125 preferably has a circular shape with a diameter of 3.8 mm to 3.9 mm in plan view.

As illustrated in FIG. 2, FIG. 3 and the like, in this embodiment, the rigid support plate 120 is provided with the openings 125 at 15 locations in 3×5 arrangement, and the piezoelectric elements 140 at the 15 locations are arranged so as to overlap with the 15 openings 125 in plan view with the flexible resin film 130 interposed therebetween. Consequently, the 15 transducers 110 in the 3×5 arrangement formed by the 15 piezoelectric elements 140 are provided, but it is needless to say that the present invention is not limited to such a configuration.

In order to sharpen the directionality of radiated sonic waves and increase the intensity thereof, it is desirable to arrange more than the 3×5 transducers 110.

In this embodiment, as illustrated in FIG. 2, the transducer array 100 further includes a lower sealing plate 150 and a wiring assembly 180.

The lower sealing plate 150 has piezoelectric-element-directed openings each having size sufficient to surround a corresponding one of the plurality of piezoelectric elements 140, and is fixed to the first surface 131 of the flexible resin film 130 by an adhesive, thermocompression bonding, or the like such that the plurality of piezoelectric elements 140 are located within the respective piezoelectric-element-directed openings in plan view.

As illustrated in FIG. 2, the thickness of the lower sealing plate 150 is greater than the thickness of the piezoelectric elements 140, and in a state in which the lower sealing plate is fixed to the first surface 131 of the flexible resin film 130, the first surface of the lower sealing plate 150 is spaced farther from the flexible resin film 130 than the upper surface electrode 146, the lower surface electrode terminal 147T, and the inner electrode terminal 144T (see FIG. 4) of each piezoelectric element 140.

The lower sealing plate 150 is made of a rigid material such as metal such as stainless steel, carbon fiber reinforced plastics, and ceramics. The lower sealing plate 150 seals the sides of a piezoelectric element group including the plurality of piezoelectric elements 140, and also serves as a mounting base to which the wiring assembly 180 is fixed.

The wiring assembly 180 forms a signal transmission path for transmitting a driving voltage signal supplied from the transmission-side unit 200 via the switching unit 400 to the first to n-th transducers 110, and for transmitting a reception voltage signal generated by the first to n-th transducers 110 to the reception-side unit 300 via the switching unit 400.

As illustrated in FIG. 2, the wiring assembly 180 has an insulating base layer 182 that is fixed to the lower sealing plate 150 by an adhesive or the like, a conductive layer 185 that is fixed to the base layer 182, and an insulating cover layer 187 that surrounds the conductive layer 185.

The base layer 182 and the cover layer 187 are each formed of insulating resin such as polyimide.

The conductive layer 185 is formed of a conductive metal such as Cu. Preferably, exposed portions of Cu that forms the conductive layer 185 are plated with Ni/Au.

In this embodiment, the conductive layer 185 includes a first wiring 185a and a second wiring 185b that are connected to the first electrode (the outer electrode 146, 147 in this embodiment) and the second electrode (the inner electrode 144 in this embodiment) of each piezoelectric element 140, respectively.

In this embodiment, as described above, the upper surface electrode 146 and the lower surface electrode 147 act as the first electrode, and the inner electrode 144 acts as the second electrode.

Therefore, the first wiring 185a is electrically connected to both a part of the upper surface electrode 146 and the lower surface electrode terminal 147T by, for example, a conductive adhesive or solder.

The second wiring 185b is electrically connected to the inner electrode terminal 144T by, for example, a conductive adhesive or solder.

The transducer array 100 further has an upper sealing plate 160 fixed to the upper surfaces of the lower sealing plate 150 and the wiring assembly 180 via flexible resin 155.

The upper sealing plate 160 has openings 162 at positions corresponding to the plurality of piezoelectric elements 140.

With the upper sealing plate 160, it is possible to stably support the wiring assembly 180 while preventing an influence on a flexural vibration operation of the transducer 110 as much as possible.

The upper sealing plate 160 is formed, for example, of metal such as stainless steel having a thickness of 0.1 mm to 0.3 mm, carbon fiber reinforced plastic, and ceramics, and the like.

The transducer array 100 further includes a sonic absorbing member 165 fixed to the upper surface of the upper sealing plate 160 by an adhesive or the like so as to cover the plurality of openings 162 of the upper sealing plate 160.

The sonic absorbing member 165 is formed of, for example, a silicone resin having a thickness of about 0.3 mm to 1.5 mm or another foamed resin.

With the sonic absorbing material 165, it is possible to effectively prevent ultrasonic waves generated by the transducers 110 from being radiated toward the side opposite to the side toward which the ultrasonic waves should be radiated (the lower side in FIG. 2).

The transducer array 100 further includes a reinforcement plate 170 that is fixed to the upper surface of the sonic absorbing member 165 by an adhesive or the like.

The reinforcing plate 170 is formed of, for example, a metal such as stainless steel having a thickness of about 0.2 mm to 0.5 mm, carbon fiber reinforced plastic, ceramics, and the like.

With reinforcement plate 170, it is possible to prevent external force from affecting the substrate 120 and the piezoelectric elements 140 as much as possible.

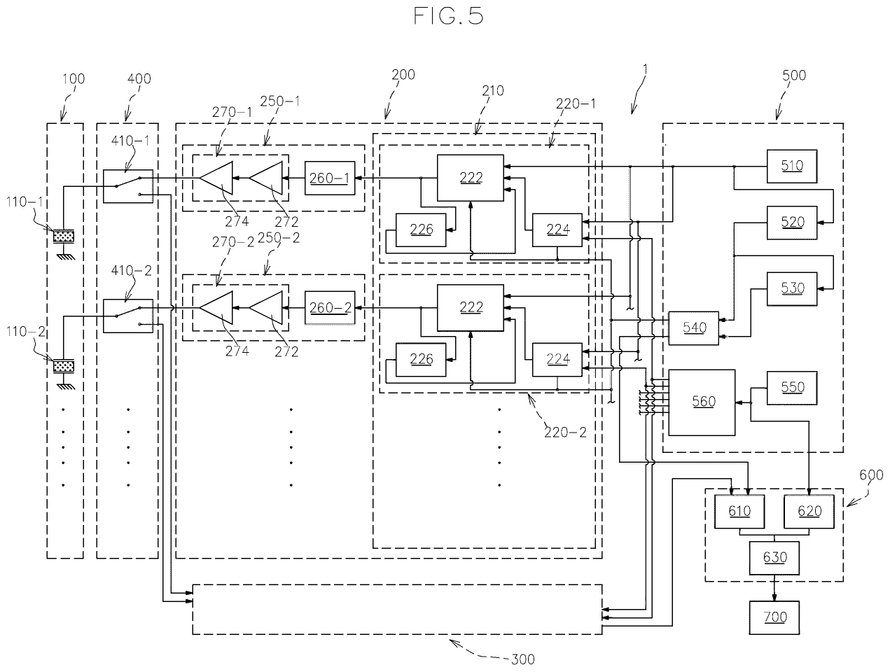

Now, the control device 500 and the transmission-side unit 200 will FIG. 5 illustrates a schematic block diagram of the control device

500 and the transmission-side unit 200. be described.

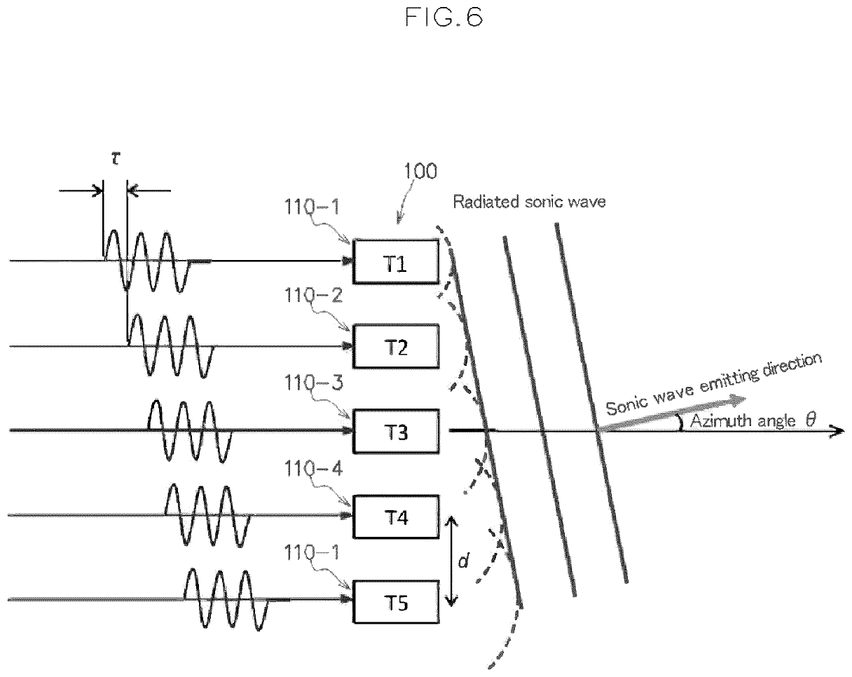

FIG. 6 illustrates a schematic operation diagram of the transducer array 100 that radiates ultrasonic waves in response to a driving voltage signal supplied from the transmission-side unit 200.

In FIG. 6, τ is delay time between a burst wave driving voltage signal applied to one of the transducers 110 (e.g., the first transducer 110-1) and a burst wave driving voltage signal applied to the adjacent transducer 110 (e.g., the second transducer 110-2), and is calculated by τ=d×sin θ/c. Herein, θ denotes the azimuth angle of the ultrasonic wave emitted from the transducer array 100, d denotes an arrangement interval between adjacent transducers, and c denotes the speed of sonic.

As illustrated in FIG. 5, the control device 500 has a clock signal generating circuit 510 that generates a clock signal with a period of, for example, 0.1 μsec to determine the operation timing of a digital circuit, a time unit setting counter circuit 520 that reduces the frequency of the clock signal generated by the clock signal generating circuit 510 to an appropriate time interval, for example, 0.1 msec to set a burst wave period, a burst interval counter circuit 530 that generates pulses at intervals of the generation timing of the burst wave driving voltage signal to be transmitted to the first to n-th transducers 110, an active counter circuit 540 outputs an active pulse signal having a time width corresponding to the total time width of the burst wave driving voltage signal to be generated on the basis of signals from the time unit setting counter circuit 520 and the burst interval counter circuit 530, an azimuth angle control unit 550 that outputs an azimuth angle signal representing the azimuth angle θ of the ultrasonic wave emitted by the transducer array 100, and a delay time control unit 560 that calculates the delay time τ on the basis of the azimuth angle signal sent from the azimuth angle control unit 550 and outputs a delay control signal.

As illustrated in FIG. 1 and FIG. 5, the transmission-side unit 200 has a transmission signal generation device 210 including first to n-th signal generating means 220-1 to 220-n (first to fifth signal generating means 220-1 to 220-5 in the illustrated embodiment) that generate driving voltage signals for the first to n-th transducers 110, respectively, and first to n-th transmission-side channels 250-1 to 250-n (first to fifth transmission-side channels 250-1 to 250-5 in the illustrated embodiment) that transmit the driving voltage signals generated by the first to n-th signal generating means 220 to the first to n-th transducers 110, respectively.

As illustrated in FIG. 5, the signal generating means 220 has a frequency divider 222, a delay time counter circuit 224, and a wave number counter circuit 226.

The frequency divider 222 divides the clock signal from the clock signal generating circuit 510 to generate a rectangular burst wave driving voltage signal with a predetermined frequency.

When the delay time counter circuit 224 is activated by an active pulse signal from the active counter circuit 540, the delay time counter circuit 224 sends a start signal pulse to the frequency divider 222 in accordance with the delay time specified by the delay control signal from the delay time control unit 560, so that the frequency divider 222 starts outputting a rectangular burst wave driving voltage signal.

The wave number counter circuit 226 sends a stop signal pulse to the frequency divider 222 when the wave number of the rectangular burst wave driving voltage signal output from the frequency divider 222 reaches a predetermined wave number.

As illustrated in FIG. 5, in this embodiment, the transmission-side unit 200 further has first to n-th transmission-side filters 260-1 to 260-n (first to fifth transmission-side filters 260-1 to 260-5 in the illustrated embodiment) that are inserted in the first to n-th transmission-side channels 250-1 to 250-n, respectively.

The transmission-side filters 260 are configured to remove at least resonant frequency components of the transducers 110 while allowing driving frequency components to pass.

The transmission-side filters 260 may be low-pass filters or band-pass filters configured to remove the resonant frequency components of the transducers while allowing the driving frequency components to pass, or band-reject filters that remove only the resonant frequencies of the transducers 110 in a pinpoint manner.

In a configuration in which the transmission-side filters 260 are bandpass filters, the bandpass filters are preferably configured to pass only frequency components within ±10% of the driving frequency.

With this configuration, it is possible to effectively remove or reduce the resonant frequency (e.g., 70 kHz) components of the non-resonant transducers 110 while effectively passing the driving frequencies (30 to 50 kHz) required for detecting an object several meters ahead.

For example, in a case where the ultrasonic phased array sensor 1 according to this embodiment is mounted on a device such as a service robot whose maximum relative speed difference v with respect to an obstacle is about 10 km/h (=2.78 m/sec), Δf/f=±v/c=±0.00808(=±0.808%) is established.

Herein, f denotes the frequency of the ultrasonic wave, Δf denotes frequency fluctuation due to the Doppler effect, and c denotes the speed of sonic.

Therefore, when the bandpass filters used as the transmission-side filters 260 are configured to pass only frequency components within ±1% of the driving frequency, the influence of the Doppler effect can be reduced as much as possible.

By causing the rectangular burst wave driving voltage signals to pass through the transmission-side filters 260, the rectangular burst wave driving voltage signals are converted to sine burst wave driving voltage signals (see FIG. 6) with the same fundamental frequency.

Consequently, a sudden rising and falling waveform of the driving voltage signal in each cycle, which occurs in the case of a square wave, is converted into a gradual waveform.

In this embodiment, as illustrated in FIG. 5, the transmission-side unit 200 has power amplifier circuits 270 inserted in the transmission-side channels 250 downstream of the transmission-side filters 260 in the signal transmission direction.

The power amplifier circuit 270 includes a buffer circuit 272 and an amplifier circuit 274.

Now, the reception-side unit 300 will be described.

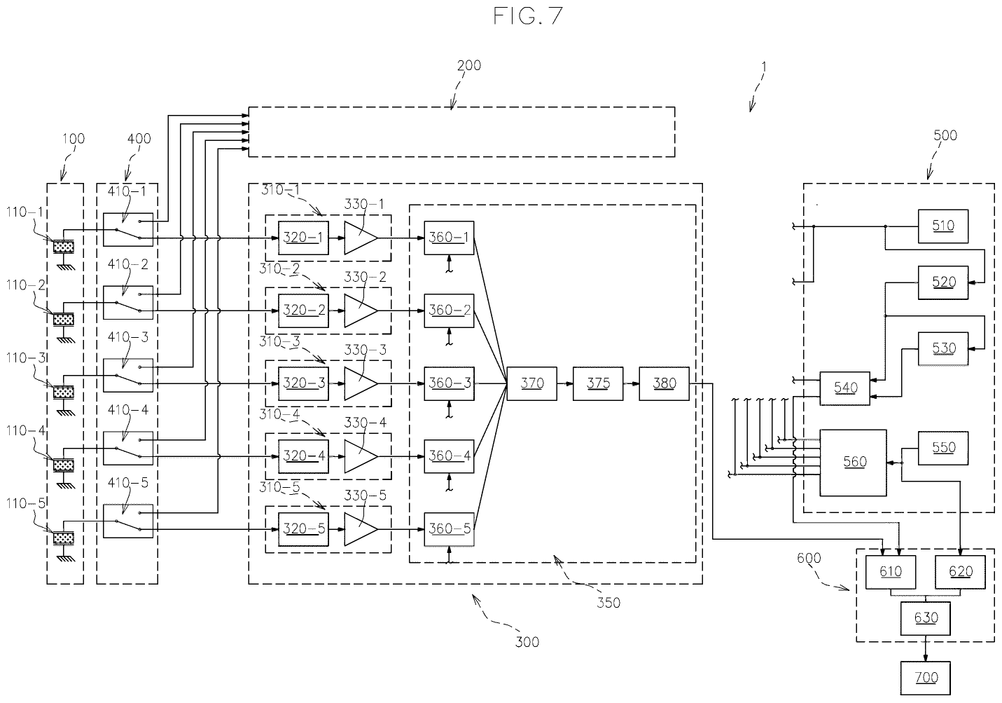

FIG. 7 illustrates a schematic block diagram of the reception-side unit 300 and the control device 500.

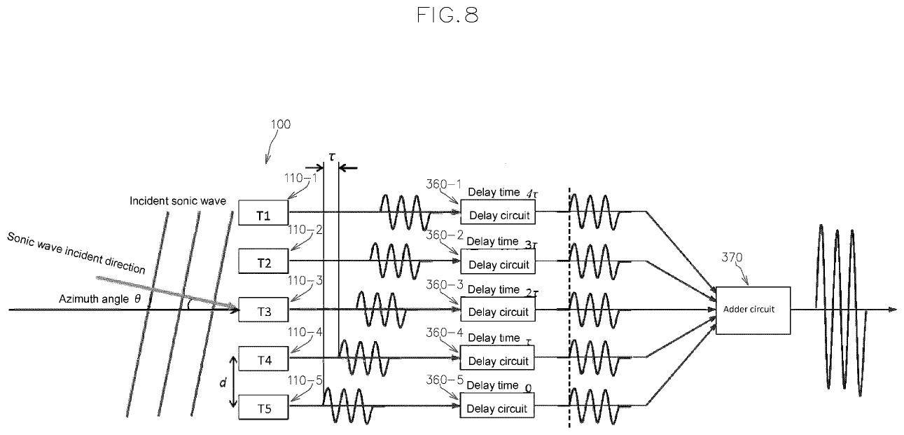

FIG. 8 illustrates a schematic operation diagram of the reception-side unit 300 which processes the reception voltage signal generated by the transducer array 100 in response to reception of an ultrasonic wave.

As illustrated in FIG. 1 and FIG. 7, the reception-side unit 300 has first to n-th reception-side channels 310-1 to 310-n (first to fifth reception-side channels 310-1 to 310-5 in the illustrated embodiment) capable of receiving reception voltage signals generated by the first to n-th transducers 110-1 to 110-n, respectively, first to n-th reception-side filters 320-1 to 320-n (first to fifth reception-side filters 320-1 to 320-5 in the illustrated embodiment) inserted in the first to n-th reception-side channels 310-1 to 310-n, respectively, and a reception signal processing device 350 that processes reception voltage signals from the first to n-th reception-side channels 320-1 to 320-n.

The reception-side filters 320 are configured to remove at least the resonant frequency components of the transducers while allowing the driving frequency components to pass.

The reception-side filters 320 may be low-pass or band-pass filters configured to remove the resonant frequency components of the transducers while allowing the driving frequency components to pass, or band-reject filters that remove only the resonant frequency components of the transducers in a pinpoint manner.

In a configuration in which the reception-side filters 320 are bandpass filters, the bandpass filters are preferably configured to pass only frequency components within ±10% of the driving frequency.

With this configuration, it is possible to effectively remove or reduce the resonant frequency (e.g., 70 kHz) components of non-resonant transducers while effectively passing the driving frequency (30 to 50 kHz) required for detecting an object several meters ahead.

In a case where the ultrasonic phased array sensor 1 according to this embodiment is mounted on a device such as a service robot whose maximum relative speed difference v with respect to an obstacle is about 10 km/h (=2.78 m/sec), the bandpass filters used as the reception-side filters 320 are preferably configured to allow only frequency components of ±1% of the driving frequency to pass, similar to the transmission-side filter 260.

In this embodiment, as illustrated in FIG. 7, the reception-side unit 300 has first to n-th low-noise amplifier circuits 330-1 to 330-n (first to fifth low-noise amplifier circuits 330-1 to 330-5 in the illustrated embodiment) inserted in the first to n-th reception-side channels 310-1 to 310-n, respectively, downstream of the first to n-th reception-side filters 320-1 to 320-n in the signal transmission direction.

As illustrated in FIG. 7, the reception signal processing device 350 has first to n-th delay circuits 360-1 to 360-n (first to fifth delay circuits 360-1 to 360-5 in the illustrated embodiment) capable of delaying the reception voltage signals of the first to n-th reception-side channels 310-1 to 310-n by corresponding predetermined times, an adder circuit 370 that adds output signals of the first to n-th delay circuits 360-1 to 360-n, and a detector 380 that generates a pulse signal having a width corresponding to the duration of the added reception voltage signal generated by the adder circuit 370 (the time width of the entire signal).

The delay times of the 1st to n-th delay circuits 360-1 to 360-n are set such that, among the reception voltage signals generated by the transducer array 100 in response to reception of ultrasonic waves, only the reception voltage signals due to return ultrasonic waves at an azimuth angle θ that are reflected back from an obstacle that is at the azimuth angle θ when the transducer array 100 radiates the ultrasonic waves are matched on the time axis.

Specifically, the first to n-th delay circuits 360-1 to 360-n delay respective reception voltage signals by delay times based on respective delay control signals for the 1st to n-th reception-side channels 310-1 to 310-n transmitted from the delay time control unit 560.

In the example illustrated in FIG. 8, the delay time of the fifth delay circuit 360-5, which delays the reception voltage signal from the fifth transducer 110-5, is set to zero, and the delay time of the fourth delay circuit 360-4, which delays the reception voltage signal from the fourth transducer 110-4, is set to a time τ calculated based on the arrangement interval d between the fourth delay circuit 360-4 and the adjacent fifth transducer 110-5, the azimuth angle θ and the speed of sonic c, with the reception voltage signal from the fifth transducer 110-5 as a reference.

The delay time of the third delay circuit 360-3, which delays the reception voltage signal from the third transducer 110-3, is set to the time τ with respect to the reception voltage signal from the adjacent fourth transducer 110-4, that is, a time 2τ with respect to the reception voltage signal from the fifth transducer 110-5.

In the same way, the delay time of the second delay circuit 360-2, which delays the reception voltage signal from the second transducer 110-2, is set to time τ with respect to the reception voltage signal from the adjacent third transducer 110-3, i.e., time 3τ with reference to the reception voltage signal from the fifth transducer 110-5, and the delay time of the first delay circuit 360-1, which delays the reception voltage signal from the first transducer 110-1, is set to the time τ with respect to the reception voltage signal from the adjacent second transducer 110-2, i.e., time 4τ with reference to the reception voltage signal from the fifth transducer 110-5.

The adder circuit 370 adds reception voltage signals of the first to n-th reception-side channels 310-1 to 310-n whose time axes are aligned by the first to n-th delay circuits 360-1 to 360-n.

According to this configuration, it is possible to effectively avoid false recognition of a virtual image where an object existing in the direction other than the azimuth angle θ at which the ultrasonic wave is radiated is detected as an obstacle existing at the azimuth angle θ.

That is, in a case where there is only one transducer that generates a reception voltage signal in response to reception of a return ultrasonic wave, it is not possible to detect only the return ultrasonic wave at the azimuth angle θ, which is radiated at the azimuth angle θ, reflected by an obstacle existing at the azimuth angle θ, and returned.

In detail, in a case where there is only one transducer that receives the return ultrasonic wave, in addition to detection of the obstacle based on the return ultrasonic wave at the azimuth angle θ, there is a possibility of detecting a virtual image based on multiple reflected ultrasonic waves that are reflected back from the obstacle and then reflected by other obstacles in other directions.

In contrast, in the phased array sensor 1 according to this embodiment, the first to n-th transducers 110-1 to 110-n are used for both ultrasonic wave transmission and ultrasonic wave reception, so that only the reception voltage signal due to the return ultrasonic wave at the azimuth angle θ that are radiated toward the azimuth angle θ and reflected back by an obstacle present at the azimuth angle θ can be matched with respect to the time axis, and detection of a virtual image can be effectively avoided.

In this embodiment, the detector 380 is an envelope detector that extracts a waveform that connects the positive peaks of each period in the added reception voltage signal generated by the adder circuit 370.

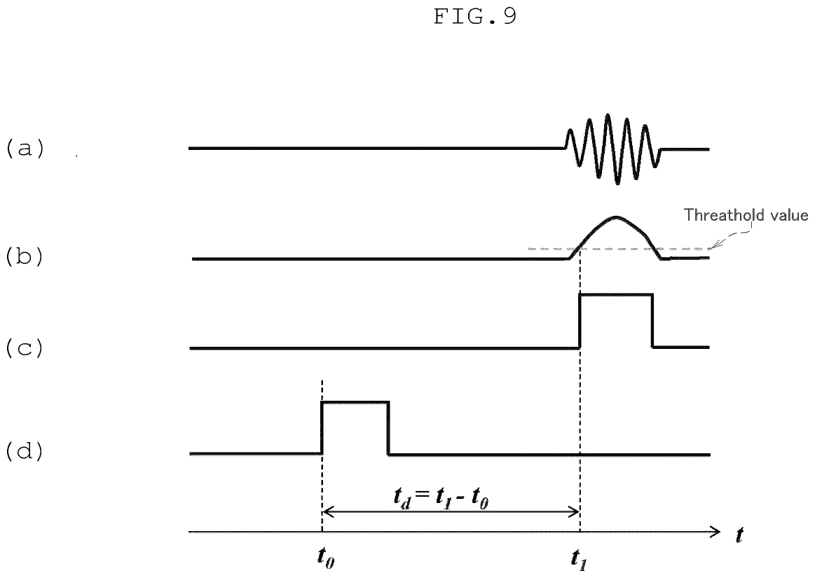

FIG. 9A illustrates the waveform of the output signal from the adder 370, and FIG. 9B illustrates the output signal waveform of the detector 380 (the envelope detector in this embodiment).

In this embodiment, as illustrated in FIG. 7, the reception signal processing device 350 has a signal processing unit 375 between the adder 370 and the detector 380 in the signal transmission direction.

The signal processing unit 375 may include a variable gain amplifier (not illustrated), a bandpass filter (not illustrated), and a logarithmic amplifier (not illustrated).

The variable gain amplifier is configured such that the amplification gain increases as a time difference from the emission of ultrasonic waves from the transducer array 100 by the driving voltage signals from the transmission-side unit 200 until the reception of the return ultrasonic waves by the transducer array 100 increases.

The variable gain amplifier is provided in consideration that the farther an obstacle is, the greater the attenuation of the return ultrasonic waves is and the smaller the amplitude of the reception voltage signals is.

The bandpass filter is configured to pass only driving frequency components, for example, 30 kHz to 50 kHz.

The logarithmic amplifier is configured so as to cause a gain for small amplitude signals to be reduced and also cause a gain for large amplitude signals to be increased.

That is, in order to amplify small amplitude signals in the reception voltage signal, it is necessary to set the gain large. However, when the gain setting is the same for all reception voltage signals, large amplitude signals saturate and distortion occurs.

The logarithmic amplifier can prevent such inconvenience, expand an amplitude range of signals that can be amplified, and effectively suppress distortion of an output signal of the detector.

As illustrated in FIG. 1, FIG. 5, and FIG. 7, the detection device 600 has a time difference detection unit 610, an orientation detection unit 620, and a position detection unit 630.

The time difference detection unit 610 is configured to detect a time difference td (td=t1−t0 in the examples of FIGS. 9C and 9D) between a transmission timing signal (FIG. 9D) based on a driving voltage signal sent from the control device 500 and a reception timing signal (FIG. 9C) based on a reception voltage signal sent from the detector 380. The timing t1 which the reception timing signal is generated is a point in time at which the reception voltage signal from the detector 380 exceeds a predetermined threshold value.

The orientation detection unit 620 is configured to recognize the azimuth angle θ at which the transducer array 100 radiates the ultrasonic waves, on the basis of the azimuth angle information sent from the control device 500.

The position detection unit 630 identifies the position of an obstacle on the basis of a distance to the obstacle calculated based on a detection result of the time difference detection unit 610, and the azimuth angle of the obstacle recognized by the orientation detection unit 620.

As illustrated in FIG. 1, FIG. 5, and FIG. 7, the phased array sensor 1 according to this embodiment further has a display device 700 that displays position information of the obstacle identified by the detection device 600.

As illustrated in FIG. 5 and FIG. 7, the switching unit 400 has first to n-th changeover switches 410-1 to 410-n (first to fifth changeover switches 410-1 to 410-5 in the illustrated embodiment).

The first to n-th changeover switches 410-1 to 410-n are configured to, on the basis of a control signal from the control device 500, selectively take a transmission state in which the first to n-th transducers 110-1 to 100-n are electrically connected to the first to n-th transmission-side channels 250-1 to 250-n, respectively, to cause the transducer array 100 to be in an ultrasonic wave transmission operating state, and a reception state in which the first to n-th transducers 110-1 to 110-n are electrically connected to the first to n-th reception-side channels 310-1 to 310-n, respectively, to cause the transducer array 100 to be in an ultrasonic wave reception operating state.

FIG. 5 illustrates the transmission state of the first to n-th changeover switches 410-1 to 410-n, and FIG. 7 illustrates the reception state of the first to n-th changeover switches 410-1 to 410-n.

The control device 500 sets the first to n-th changeover switches 410-1 to 410-n to the transmission state, and immediately after completing transmission of the driving voltage signal to the first to n-th transducers 110-1 to 110-n, the control device 500 switches the first to n-th changeover switches 410-1 to 410-n to the reception state.

The ultrasonic phased array sensor 1 according to this embodiment has the following effects.

That is, the transducer is of a non-resonant type that can effectively radiate an ultrasonic wave even when a burst wave driving voltage signal with a driving frequency (e.g., 40 kHz) that is sufficiently lower than the resonant frequency of the transducer 110 (e.g., 70 kHz) is used. However, even if a driving voltage with a driving frequency that is sufficiently lower than the resonant frequency of the transducer 110 is applied to the transducer 110 to cause the transducer to radiate an ultrasonic wave, when the burst wave driving voltage signal has a waveform that is a rectangular wave or close to a rectangular wave, not only vibration at the driving frequency but also vibration at the resonant frequency of the transducer 110 will be generated in the transducer 110.

Therefore, distortion occurs in the generated ultrasonic wave waveform, and the damped vibration at the resonant frequency of the transducers 110 after the application of the driving voltage signal ends also becomes large and long.

In particular, the damped vibration at the resonant frequency of the transducers 110 is combined with the vibration of the transducers 110 caused by the ultrasonic wave that is reflected back from an obstacle after the transducer array 100 is switched from the transmission operating state to the reception operating state, and significantly deteriorates the accuracy of detecting the position of the obstacle.

With respect to this point, in the ultrasonic phased array sensor 1 according to this embodiment, the first to n-th transmission-side filters 260-1 to 260-n that remove at least the resonant frequency components of the transducers 110 while allowing driving frequency components to pass are inserted in the first to n-th transmission-side channels 250-1 to 250-n.

Therefore, a burst wave driving voltage converted from a rectangular wave to a sine wave is applied to the transducers 110, the resonant vibration of the transducers 110 can be effectively prevented or reduced, and the inconvenience caused by the resonant vibration of the transducers 110 can be effectively prevented or reduced.

In addition, as described above, in this embodiment, a sine wave burst wave driving voltage signal is applied to the transducers 110. Even in this case, resonant vibration may occur in the transducers 110, although the vibration is smaller than that in the case of a rectangular burst wave driving voltage signal.

In this regard, in the ultrasonic phased array sensor 1 according to this embodiment, the 1st to n-th reception-side filters 320-1 to 320-n that remove at least the resonant frequency components of the transducers 110 while allowing the driving frequency components to pass are inserted in the 1st to n-th reception-side channels 310-1 to 310-n.

Consequently, it possible to effectively prevent or reduce resonant vibration of transducers 110 from adversely affecting the reception voltage signal generated by the transducer array 100. For example, it is possible to effectively prevent or reduce the adverse effect that the amplifier is saturated by a signal based on damped vibration at the resonant frequency of the transducers 110 when the reception voltage signal is amplified by an amplifier circuit.

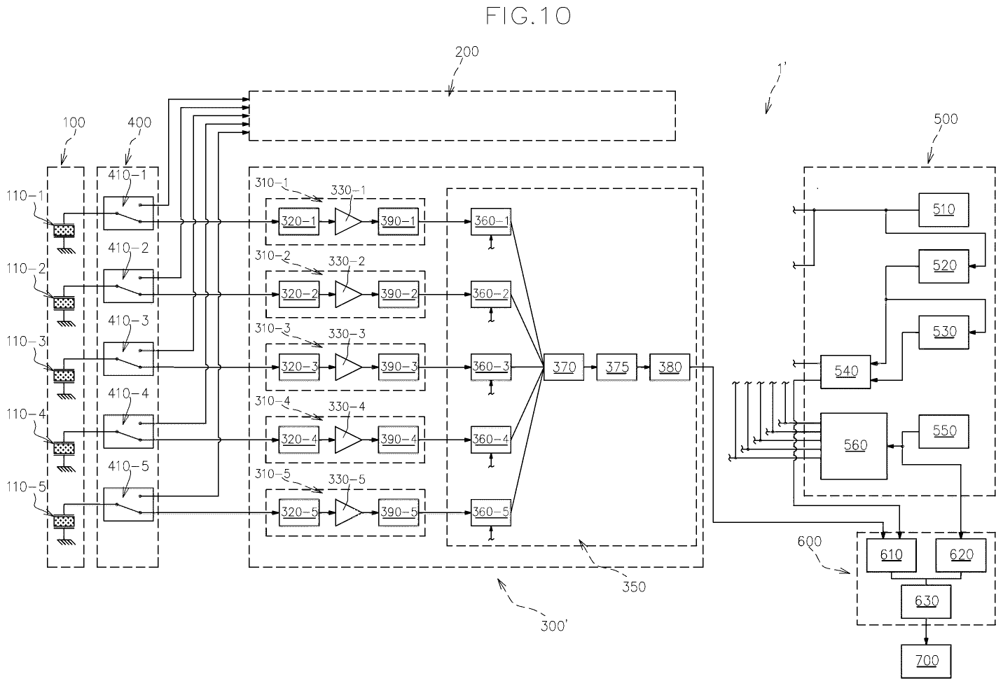

FIG. 10 illustrates a schematic block diagram of an ultrasonic phased array sensor 1′ mounted with a reception-side unit 300′ according to a modification instead of the reception-side unit 300.

In the drawings, the same members as those in this embodiment are denoted by the same reference numerals, and description therefore will be omitted as appropriate.

Compared to the reception-side unit 300, the reception-side unit 300′ has first to n-th A/D converters 390-1 to 390-n in front of the first to n-th delay circuits 360-1 to 360-n, respectively (on the upstream side in the signal transmission direction). The reception-side unit 300′ is configured to perform processing reception voltage signals by digital signal processing at the delay circuits 360-1 to 360-n and the subsequent circuits. In the reception-side unit 300′, the detector 380 is an orthogonal detector.

The ultrasonic phased array sensor 1′ mounted with the reception-side unit 300′ can also obtain the same effect as the ultrasonic phased array sensor 1 according to this embodiment.

### Second Embodiment

Hereinafter, another embodiment of the phased array sensor according to the present invention will be described with reference to the accompanying drawings.

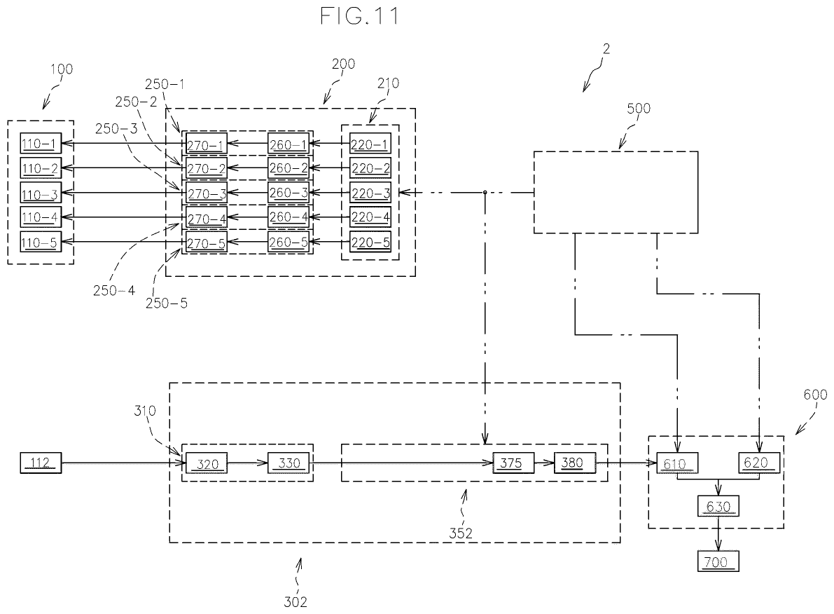

FIG. 11 illustrates a schematic block diagram of a phased array sensor 2 according to this embodiment.

In the drawings, the same members as those in the first embodiment are denoted by the same reference numerals, and detailed description thereof will be omitted as appropriate.

As described above, the phased array sensor 1 according to the first embodiment is configured such that the operating states of the 1st to n-th transducers 110 are switched between an ultrasonic wave transmission operating state and an ultrasonic wave reception operating state by the 1st to n-th changeover switches 410.

In contrast, in the phased array sensor 2 according to this embodiment, first to n-th transducers 110 function only for transmission of ultrasonic waves, and a single aerial ultrasonic transducer 112 dedicated to reception is provided, separate from the first to n-th transducers 110.

That is, compared to the sensor 1 according to the first embodiment, the phased array sensor 2 omits the switching unit 400, includes the reception transducer 112 and also includes a reception-side unit 302 instead of the reception-side unit 300.

Specifically, as illustrated in FIG. 11, the phased array sensor 2 includes the transducer array 100 in which the first to n-th transducers 110-1 to 110-n (the first to fifth transducers 110-1 to 110-5 in the illustration) are used exclusively for transmitting ultrasonic waves, the transmission signal generation device 210, the first to n-th transmission-side channels 250-1 to 250-n (the first to fifth transmission-side channels 250-1 to 250-5 in the illustrated embodiment), the first to n-th transmission-side filters 260-1 to 260-n (the first to fifth transmission-side filters 260-1 to 260-5 in the illustrated embodiment), the single receiving aerial ultrasonic transducer 112 capable of receiving return ultrasonic waves that has been transmitted from the first to n-th transducers 110-1 to 110-n acting as transducers dedicated for transmission and then reflected back from an obstacle to be detected, the reception-side channels 310 capable of receiving a reception voltage signal generated by the reception transducer 112, the reception-side filters 320 inserted in the reception-side channels 310, a reception signal processing device 352 including a detector 380 for generating a signal having a width corresponding to the duration of output signals of the receiving-side channels 320, the control device 500 for controlling the transmission signal generation device 210 and the reception signal processing device 352, and the detection device 600 that detects the position of an obstacle on the basis of the time difference between a transmission timing signal based on a driving voltage signal sent from the control device 500 and a reception timing signal based on a reception voltage signal sent from the detector 380, as well as azimuth angle information sent from the control device 500.

The reception transducer 112 may be of a non-resonant type, like the transducers 110 that act as transmission transducers. In contrast, the reception transducer 112 may be of a resonant type that performs resonant vibration at the driving frequency of the driving voltage signal generated by the transmission signal generation device 210.

In a case where the reception transducer 112 is of a non-resonant type, the reception-side filters 320 are configured to remove at least the resonant frequency components of the reception transducer 112 while allowing the driving frequency components to pass.

In a case where the reception transducer 112 is of the resonant type, the reception-side filters 320 are noise reduction filters.

As illustrated in FIG. 11, the reception signal processing device 352 includes the signal processing unit 375 on the upstream side of the detector 380 with respect to the signal transmission direction.

The signal processing unit 375 may include a variable gain amplifier (not illustrated), a bandpass filter (not illustrated), and a logarithmic amplifier (not illustrated).

### Third Embodiment

Hereinafter, still another embodiment of the phased array sensor according to the present invention will be described with reference to the accompanying drawings.

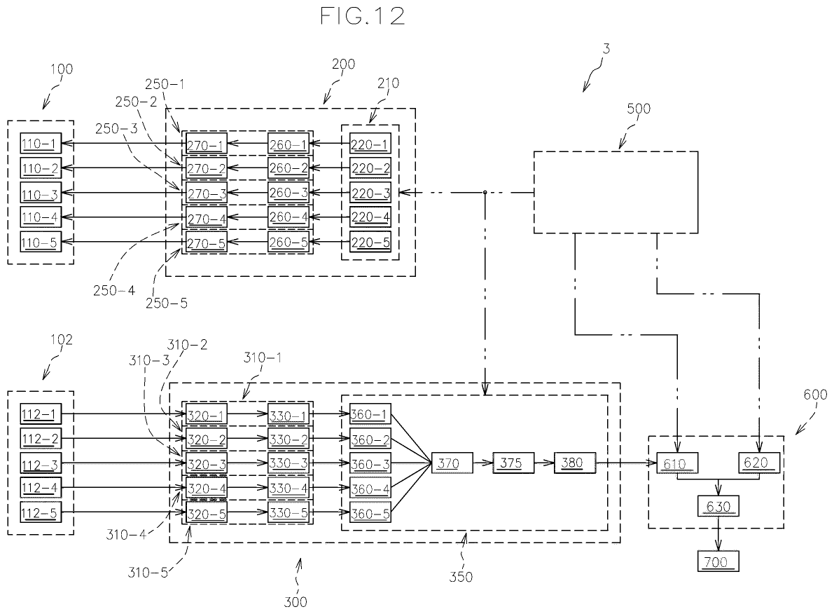

FIG. 12 illustrates a schematic block diagram of a phased array sensor 3 according to this embodiment.

In the drawings, the same members as those in the embodiments 1 and 2 are denoted by the same reference numerals, and detailed description thereof will be omitted as appropriate.

Compared to the phased array sensor 2 according to the second embodiment, the phased array sensor 3 according to this embodiment has first to n-th reception transducers 112-1 to 112-n acting as transmission transducers instead of the single reception transducer 112, the first to n-th reception transducers 112-1 to 112-n corresponding to the first to n-th transducers 110-1 to 110-n, respectively, and has the reception-side unit 300 instead of the reception-side unit 302.

Specifically, as illustrated in FIG. 12, the phased array sensor 3 includes the transducer array 100 having the first to n-th transducers 110-1 to 110-n (the first to fifth transducers 110-1 to 110-5 in the illustrated embodiment) used exclusively for ultrasonic wave transmission; the transmission signal generation device 210; the first to n-th transmission-side channels 250-1 to 250-n (the first to fifth transmission-side channels 250-1 to 250-5 in the illustrated embodiment); the first to n-th transmission-side filters 260-1 to 260-n (the first to fifth transmission-side filters 260-1 to 260-5 in the illustrated embodiment); a reception transducer array 102 including the first to n-th reception transducers 112-1 to 112-n (the first to fifth reception transducers 112-1 to 112-n in the illustrated embodiment); the first to n-th reception-side channels 310-1 to 310-n (the first to fifth reception-side channels 310-1 to 310-5 in the illustrated embodiment); the first to n-th reception-side filters 320-1 to 320-n (the first to fifth reception-side filters 320-1 to 320-5 in the illustrated embodiment); the first to n-th reception-side filters 320-2 to 320-n (the first to fifth reception-side filters 320-2 to 320-5 in the illustrated embodiment); the reception signal processing device 350 including the first to n-th delay circuits 360-1 to 360-n (the first to fifth delay circuits 360-1 to 360-5 in the illustrated embodiment) capable of delaying the reception voltage signals of the first to n-th reception-side channels 310-1 to 310-n by a predetermined time, the adder circuit 370 which adds up the output signals of the first to n-th delay circuits 360-1 to 360-n, and the detector 380 that generates a signal having a width corresponding to the duration of the output signal of the adder circuit 370; the control device 500 that controls the transmission signal generation device 210 and the reception signal processing device 350; and the detection device 600 that detects the position of an obstacle on the basis of the time difference between a transmission timing signal based on a driving voltage signal sent from the control device 500 and a reception timing signal based on a reception voltage signal sent from the detector 380, as well as azimuth angle information sent from the control device 500.

In this embodiment, the reception transducers 112-1 to 112-n may be of a non-resonant type, or, alternatively, may be of a resonant type that performs resonant vibration due to the driving frequency of the driving voltage signal generated by the transmission signal generation device 210.

In a case where the reception transducers 112-1 to 112-n are of the non-resonant type, the reception-side filters 320-1 to 320-n are configured to remove at least the resonant frequency components of the reception transducers 112-1 to 112-n while allowing the driving frequency components to pass.

In a case where the reception transducers 112-1 to 112-n are of the resonant type, the reception-side filters 320-1 to 320-n are noise reduction filters.

The phased array sensor 3 according to this embodiment can effectively avoid detection of a virtual image compared to the phased array sensor 2 according to the second embodiment.

That is, the phased array sensor 2 according to the second embodiment has only the single reception transducer 112, and therefore cannot detect only the return ultrasonic waves at the azimuth angle θ that are radiated at the azimuth angle θ by the transmission transducer array 100 at the azimuth angle θ and then reflected back by an obstacle present at that azimuth angle θ.

In detail, the phased array sensor 2 may detect an obstacle based on the return ultrasonic waves at the azimuth angle θ, and, in addition, a virtual image based on multiple reflected ultrasonic waves that are reflected by the obstacle to be detected and then are reflected back by other obstacles in other directions.

In contrast, in the same manner as the phased array sensor 1 according to the first embodiment, the phased array sensor 3 according to this embodiment can match only the reception voltage signal due to the return ultrasonic waves at the azimuth angle θ that are reflected and returned by the obstacle present at the azimuth angle θ at which an ultrasonic wave is radiated by the transducer array 100 having the first to n-th transducers 110-1 to 110-n that act as transmitters, with respect to the time axis, and can effectively avoid detection of a virtual image.

In the second and third embodiments, in the same manner as the modification of the first embodiment, it is also possible to provide a reception-side unit (not illustrated) configured to perform a digital signal process instead of the reception-side unit 300.

### DESCRIPTION OF THE REFERENCE NUMERALS

1-3 ultrasonic phased array sensor
100 transducer array
102 reception transducer array
110 transducer
112 reception transducer
210 transmission signal generation device
220 signal generating means
250 transmission-side channel
260 transmission-side filter
310 reception-side channel
320 reception-side filter
330 low-noise amplifier circuit
350, 352 reception signal processing device
410 changeover switch
500 control device

1. An ultrasonic phased array sensor comprising:
a transducer array including a plurality of non-resonant aerial ultrasonic transducers arranged at a predetermined interval;
a transmission signal generation device including a plurality of signal generating means corresponding to the plurality of transducers, respectively, the signal generating means capable of a generating rectangular burst wave driving voltage signal, which has a predetermined driving frequency lower than a resonant frequency of a transducer of the plurality of transducers, at a delay timing set for the corresponding transducer;
a plurality of transmission-side channels electrically connected to the plurality of signal generating means, respectively;
a plurality of transmission-side filters inserted in the plurality of transmission-side channels, respectively;
a plurality of reception-side channels capable of receiving reception voltage signals generated by the plurality of transducers, respectively;
a plurality of reception-side filters inserted in the plurality of reception-side channels, respectively;
a reception signal processing device including a plurality delay circuits capable of delaying the reception voltage signals of the plurality of reception-side channels by respective predetermined times, an adder circuit that adds output signals of the plurality of delay circuits, and a detector that generates a signal having a width corresponding to a duration of an output signal of the adder circuit;
a control device that controls the transmission signal generation device and the reception signal processing device;
a detection device that detects a position of an obstacle on the basis of a time difference between a transmission timing signal that is based on the driving voltage signal sent from the control device and a reception timing signal that is based on the reception voltage signal sent from the detector sent from the detector, as well as an azimuth angle information sent from the control device; and
a plurality of changeover switches that changeover operating states of the plurality of transducers between a transmission operating state and a reception operating state, respectively, on the basis of a control signal from the control device,
wherein the plurality of transmission-side filters and the plurality of reception-side filters are configured to remove at least resonant frequency components of the transducers while allowing driving frequency components to pass.

2. The ultrasonic phased array sensor according to claim 1, wherein the plurality of transmission-side filters is a band-pass filter configured to remove the resonant frequency component of the transducer while allowing the driving frequency component to pass.

3. The ultrasonic phased array sensor according to claim 2, wherein the plurality of reception-side filters is a band-pass filter configured to remove the resonant frequency component of the transducer while allowing the driving frequency component to pass.

4. The ultrasonic phased array sensor according to claim 2, wherein the bandpass filter is configured to pass only frequency component within ±10% of the driving frequency.

5. The ultrasonic phased array sensor according to claim 2, wherein the bandpass filter is configured to pass only frequency component within ±1% of the driving frequency.

6. The ultrasonic phased array sensor according to claim 1, wherein the plurality of transmission-side filters comprises a low-pass filter or a band-reject filter configured to remove the resonant frequency component of the transducer while allowing the driving frequency component to pass.

7. The ultrasonic phased array sensor according to claim 1, comprising a plurality of low-noise amplifier circuits inserted in the plurality of reception-side channels, respectively, downstream of the plurality of reception-side filters in a signal transmission direction.

8. An ultrasonic phased array sensor comprising:
a transmission transducer array including a plurality of non-resonant aerial ultrasonic transmission transducers arranged at a predetermined interval;
a transmission signal generation device including a plurality of signal generating means corresponding to the plurality of transmission transducers, respectively, the signal generating means capable of a generating rectangular burst wave driving voltage signal, which has a predetermined driving frequency lower than a resonant frequency of a transmission transducer of the plurality of transmission transducers, at a delay timing set for the corresponding transmission transducer;
a plurality of transmission-side channels electrically connected to the plurality of signal generating means, respectively;
a plurality of transmission-side filters inserted in the plurality of transmission-side channels, respectively;
an aerial ultrasonic reception transducer capable of receiving return ultrasonic waves that has been transmitted from the plurality of transmission transducers and then reflected back from an obstacle to be detected;
a reception-side channel capable of receiving a reception voltage signal generated by the reception transducer;
a reception-side filter inserted in the reception-side channel;
a reception signal processing device including a detector that generates a signal having a width corresponding to a duration of an output signal of the reception-side channel;
a control device that controls the transmission signal generation device and the reception signal processing device; and
a detection device that detects a position of an obstacle on the basis of a time difference between a transmission timing signal that is based on the driving voltage signal sent from the control device and a reception timing signal that is based on the reception voltage signal sent from the detector, as well as an azimuth angle information sent from the control device;
wherein the plurality of transmission-side filters are configured to remove at least resonant frequency components of the transducers while allowing driving frequency components to pass.

9. An ultrasonic phased array sensor comprising:
a transmission transducer array including a plurality of non-resonant aerial ultrasonic transmission transducers arranged at a predetermined interval;
a transmission signal generation device including a plurality of signal generating means corresponding to the plurality of transmission transducers, respectively, the signal generating means capable of a generating rectangular burst wave driving voltage signal, which has a predetermined driving frequency lower than a resonant frequency of a transmission transducer of the plurality of transmission transducers, at a delay timing set for the corresponding transmission transducer;
a plurality of transmission-side channels electrically connected to the plurality of signal generating means, respectively;
a plurality of transmission-side filters inserted in the plurality of transmission-side channels, respectively;
a reception transducer array including a plurality of aerial ultrasonic reception transducers that correspond to the plurality of transmission transducers;
a plurality of reception-side channels capable of receiving reception voltage signals generated by the plurality of reception transducers, respectively;
a plurality of reception-side filters inserted in the plurality of reception-side channels, respectively;
a reception signal processing device including a plurality delay circuits capable of delaying the reception voltage signals of the plurality of reception-side channels by respective predetermined times, an adder circuit that adds output signals of the plurality of delay circuits, and a detector that generates a signal having a width corresponding to a duration of an output signal of the adder circuit;
a control device that controls the transmission signal generation device and the reception signal processing device; and
a detection device that detects a position of an obstacle on the basis of a time difference between a transmission timing signal that is based on the driving voltage signal sent from the control device and a reception timing signal that is based on the reception voltage signal sent from the detector, as well as an azimuth angle information sent from the control device;
wherein the plurality of transmission-side filters are configured to remove at least resonant frequency components of the transducers while allowing driving frequency components to pass.

10. The ultrasonic phased array sensor according to claim 8, wherein the reception transducer is a resonant type transducer that performs resonant vibration at the driving frequency of the driving voltage signal generated by the transmission signal generation device.

11. The ultrasonic phased array sensor according to claim 8, wherein the reception transducer is a non-resonant type transducer having a resonant frequency higher than the driving frequency of the driving voltage signal generated by the transmission signal generation device.

12. The ultrasonic phased array sensor according to claim 11, wherein the plurality of reception-side filters is configured to remove at least the resonant frequency component of the reception transducer while allowing the driving frequency components to pass.
